(19) United States
(12) Patent Application Publication
(10) Pub. No.: US 2003/0226696 A1
(43) Pub. Date: Dec. 11, 2003

(54) Non-slip clutch assembly for remote control vehicle

(75) Inventors: Robert P. Spalinski, Titusville, NJ (US); Matthew J. Del Duke, Audubon, NJ (US); Bruce E. Gavins, Levittown, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Mattel, Inc.

(21) Appl. No.: 10/358,467

(22) Filed: Feb. 5, 2003

Related U.S. Application Data
(60) Provisional application No. 60/386,374, filed on Jun. 5, 2002.

(51) Int. Cl. B62D 11/00

(52) U.S. Cl. 180/6.64

(57) ABSTRACT

The present invention is a clutch assembly for use with motor driven toys, particularly a toy vehicle configured to be maneuvered on a surface. The clutch assembly includes a clutch operably coupled with the motor and a bell housing having at least one opening in its circumferential wall with a circumferential leading edge. At least an engagement end of the clutch is rotated within the housing. The clutch engagement end has finger members that resiliently flex outwardly from a center of rotation of the clutch. Each finger member has at least one small protrusion extending outwardly from the outside circumferential surface of the finger member that engages with the leading edge when the clutch is rotated and the finger member flexes outwardly.

### CROSS-REFERENCE TO RELATED APPLICATIONS

This patent application claims priority to U.S. Patent Application No. 60/386,374, filed Jun. 5, 2002, entitled “Non-Slip Clutch Assembly for Remote Control . . . . ”

### BACKGROUND OF THE INVENTION

This invention generally relates to a clutch assembly, and more particularly to a non-slip clutch assembly for use with remote-controlled toy vehicles.

Although clutch assemblies are generally known, they generally operate through frictional engagement between components of the clutch assemblies. The frictional clutch design allows three states of operation: disengaged, partially engaged, and fully engaged. This design is fine and, in fact, preferable in many applications. However, for some applications, it might be preferable to have a clutch assembly with only two states of operation: disengaged or fully engaged.

### BRIEF SUMMARY OF THE INVENTION

Briefly stated, the present invention is a toy clutch assembly comprising a bell housing and a clutch. The bell housing has at least one opening with a leading edge. The bell housing is mounted for rotation about a central axis. The clutch is maintained at all times at least partially within the bell housing and is rotatable within the bell housing about the central axis. The clutch has at least one resiliently flexible finger member with an end that resiliently flexes outwardly away from the central axis during rotation. The at least one finger member has at least one small protrusion extending in a direction outwardly away from the central axis. The at least one protrusion engages with the leading edge when the finger member flexes outwardly at an engagement speed of the clutch.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

In the drawings:

FIG. 1 is a perspective view of the toy vehicle in which the present invention is located;

FIG. 2 is a perspective view of the toy vehicle of FIG. 1 with the top cover and rider removed;

FIG. 3 is top plan view of the drive gear train of the toy vehicle of FIG. 1;

FIG. 4 is an exploded view of the clutch assembly of the present invention;

FIG. 5 is an end plan view of the clutch of the present invention;

FIG. 6 is a perspective view of the noise-producing feature of the toy vehicle of FIG. 1;

FIG. 7 is a perspective view of the bottom of the gear train housing cover of the toy vehicle of FIG. 1; and

FIG. 8 is an exploded view of the toy vehicle of FIG. 1 with the top cover and rider removed.

### DETAILED DESCRIPTION OF THE INVENTION

Certain terminology is used in the following description for convenience only and is not limiting. The words “right”, “left”, “upper” and “lower” designate directions in the drawings to which reference is made. The terminology includes the words above specifically mentioned, derivatives thereof, and words of similar import.

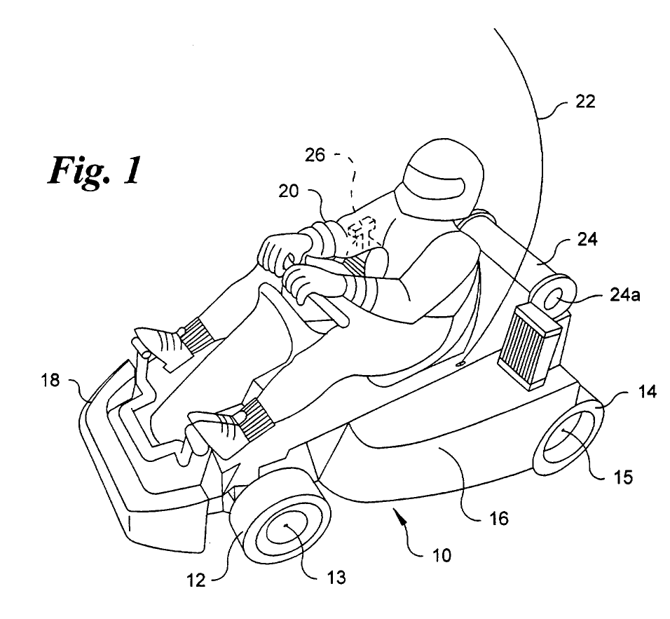

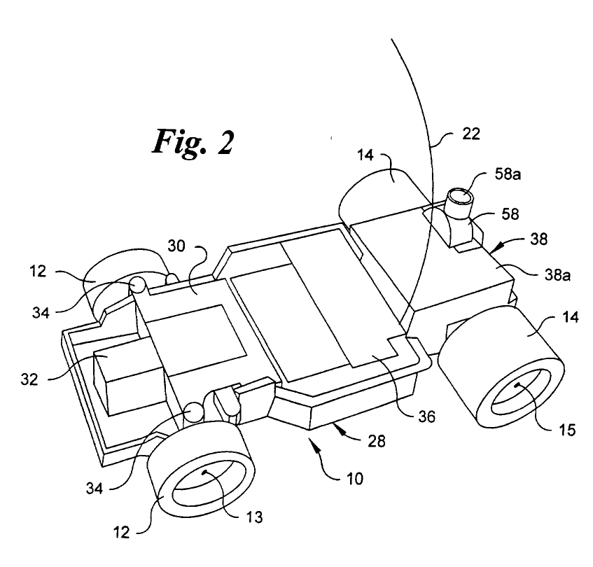

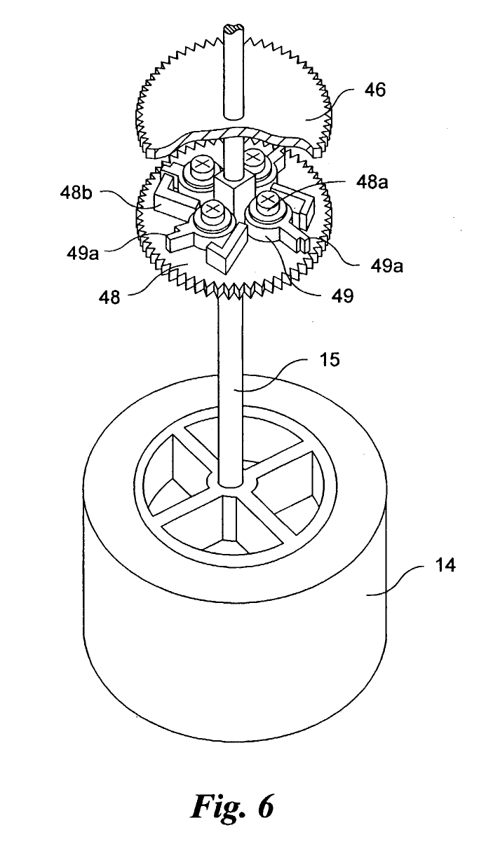

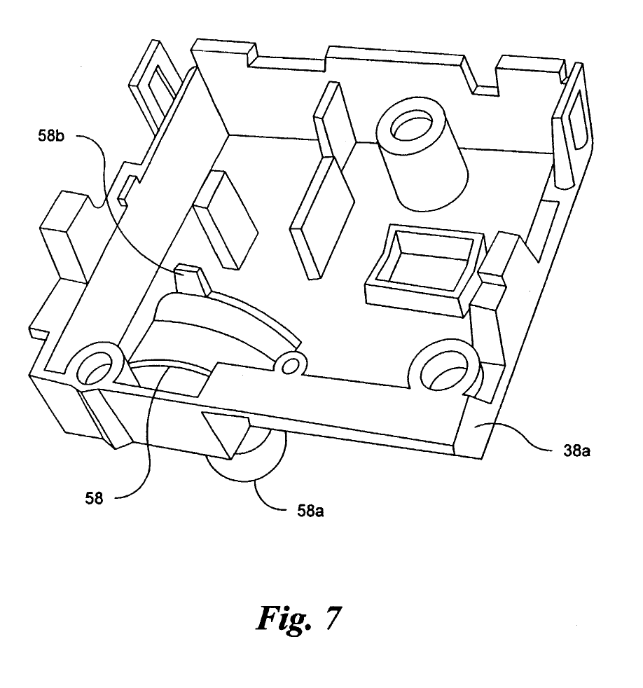

Referring to the drawings in detail, wherein like numerals indicate like elements throughout, there is shown in FIGS. 1 through 7 a preferred embodiment of a toy vehicle, indicated generally at 10, in accordance with the present invention. Referring to FIG. 1, the vehicle 10 has a top cover 16 and a bumper 18 engaged with a chassis 28 (FIG. 2). The top cover 16 is designed to simulate a go-cart. Engaged with the top of the top cover 16 is a rider 20, simulating a driver of the vehicle 10. A power switch 26 behind the rider 20 in FIG. 1 (portrayed in phantom) extends upwardly from the top cover 16, allowing a user to turn on or off the power for the vehicle 10.

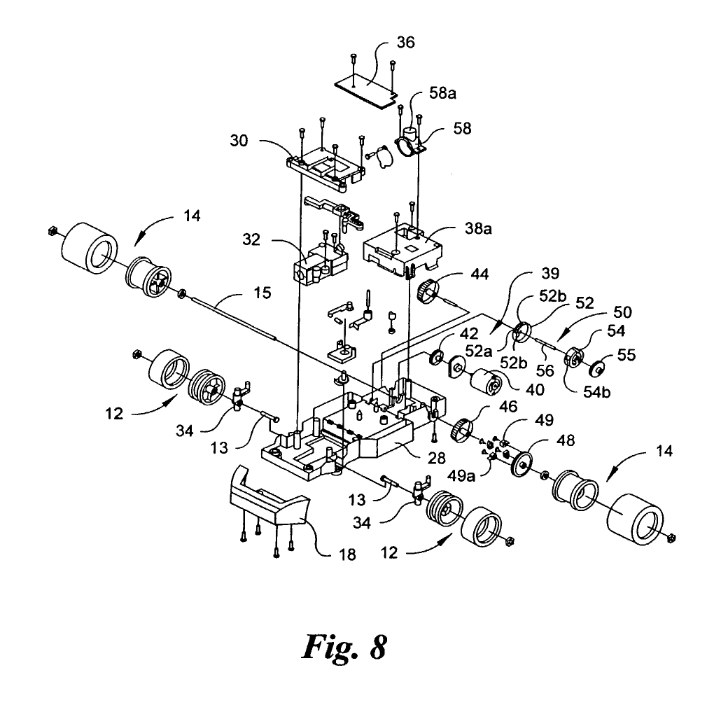

Referring to FIGS. 2 and 8, the chassis 28 can be seen with the top cover 16 and the bumper 18 removed. Engaged with the chassis 28 are a steering mechanism housing 30, a steering motor housing 32, a drive mechanism housing 38, and an on-board control unit 36. Within the steering mechanism housing 30, located proximate the front of the chassis 28, is a conventional steering mechanism (not shown) powered by a conventional steering motor (not shown). The steering mechanism controls the pivoting of steerable wheels 12, located proximate the front of the chassis 28. Each steerable wheel 12 is rotatably mounted on a steerable wheel shaft 13. The steering wheel shaft 13 is engaged with a wheel pivot member 34, extending outwardly therefrom. The wheel pivot member 34 is pivotably mounted to the chassis 28 and also pivotably mounted to the steering mechanism, allowing the steering mechanism to pivot the pivot member 34 about its connection point with the chassis 28. In this way, turning of the vehicle 10 is effectuated.

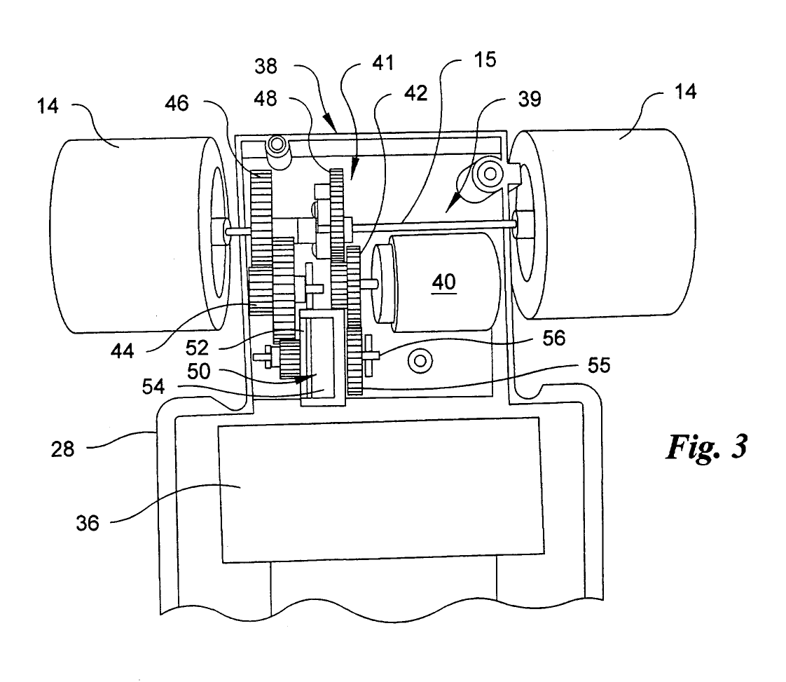

The on-board control unit 36 is conventional and maintained within the vehicle 10, engaged with the chassis 28. An antenna 22 is engaged with the control unit 36, extending upwardly therefrom through an opening in the top cover 16 (FIG. 1). The on-board control unit 36 includes a radio receiver circuit and an associated motor control circuit and is in electrical communication with the battery power supply (not shown) as well as both the steering motor and a drive motor 40 (FIG. 3). The on-board control unit 36 is configured to receive and process control signals transmitted from a remote control unit (not shown) spaced from the vehicle 10 to remotely control movement of the vehicle 10.

The drive mechanism housing 38 is located proximate the back of the chassis 28. The drive mechanism housing 38 includes a removable drive mechanism housing cover 38a. Removal of the drive mechanism housing cover 38a reveals a drive mechanism, indicated generally at 39 (FIG. 3). Referring to FIG. 3, the drive mechanism 39 includes the drive motor 40 and a gear train 41. The drive motor 40 should be of a type that can provide a proper amount of power for the vehicle 10 and be maintained within the vehicle 10, such as, but not limited to an electric motor or a small gasoline motor. A forward or a backward command received from the remote control unit will cause the drive motor 40 to rotate in the appropriate direction, transmitting power through the gear train 41 and effecting rotation of a drive wheel axle 15 located proximate the rear end of the chassis 28. A pair of toy vehicle drive wheels 14, one located at each end of the drive wheel axle 15, are rigidly engaged with the drive wheel axle 15, such that rotation of the drive wheel axle 15 effects rotation of the drive wheels 14, thereby propelling the vehicle 10. The gear train 41 has a first combined gear 42, a toy clutch assembly 50; a second combined gear 44, a first spur gear 46, and a second spur gear 48. The first combined gear 42 is rigidly engaged with the rotating member of the drive motor 40. The smaller gear of the first combined gear 42 engages with the second spur gear 48, which is rotatably maintained on the drive wheel axle 15. The second spur gear 48 is rotatable regardless of whether the drive wheel axle 15 is rotating and is used to produce a motor-like sound, as will be described below. The larger gear of the first combined gear 42 engages with the toy clutch assembly 50, which will be described below. The toy clutch assembly 50 engages with the larger gear of the second combined gear 44. The smaller gear of the second combined gear 44 then engages with the first spur gear 46. The first spur gear 46 is rigidly engaged with the drive wheel axle 15, such that rotation of the first spur gear 46 causes rotation of the drive wheel axle 15.

Referring to FIGS. 3-5, the toy clutch assembly 50 includes a clutch bell housing 52, a clutch 54, and a clutch gear 55, all rotatably mounted on a clutch shaft 56. The central axis of shaft 56 constitutes a central axis of assembly 50 and each component 52, 54, 55. The clutch 54 is rigidly engaged with the clutch gear 55. The clutch 54 is sized such that at least a proximal end portion of it fits and is maintained at all times within the clutch bell housing 52 without contacting the clutch bell housing 52 at any angular orientation, at least when the clutch is not being rotated. Referring to FIG. 5, the portion of the clutch 54 that is inserted within the clutch bell housing 52 includes at least one and preferably two, generally semi-circular, resiliently flexible finger members 54a. Each member 54a has at least one small finger member protrusion 54b on the outer circumferential (radial) edge of each finger member 54a extending in a direction outwardly away from the central axis of shaft 56, a finger member connection point 54c which connects the two finger members 54a to the rest of the clutch 54, and a gap 54d between the ends of the two finger members 54a. The finger members 54a are designed to flex resiliently radially outwardly from the center of the clutch 54 and central axis of shaft 56. When the clutch 54 is rotated above a threshold rotational speed, flexing of the finger members 54a causes the finger member protrusions 54b to move beyond the original diameter of the clutch 54, bending proximate the connection point 54c and widening the finger member gap 54d diametrically opposite the connection point 54c, and come into contact with the clutch bell housing 52. The threshold speed of the clutch 54 is dependent upon a spring tension of the finger members 54a. The spring tension is a function of thickness and material of the finger members 54a. In this way, the engagement speed can be adjusted by varying the thickness, shape and/or material of the finger members 54a to enable the toy clutch assembly 50 to work with a range of motor speeds for vehicles of different scale sizes and loading weights. Of course, engagement speed should be less than normal operating speed(s) to maintain engagement of the clutch assembly during operation.

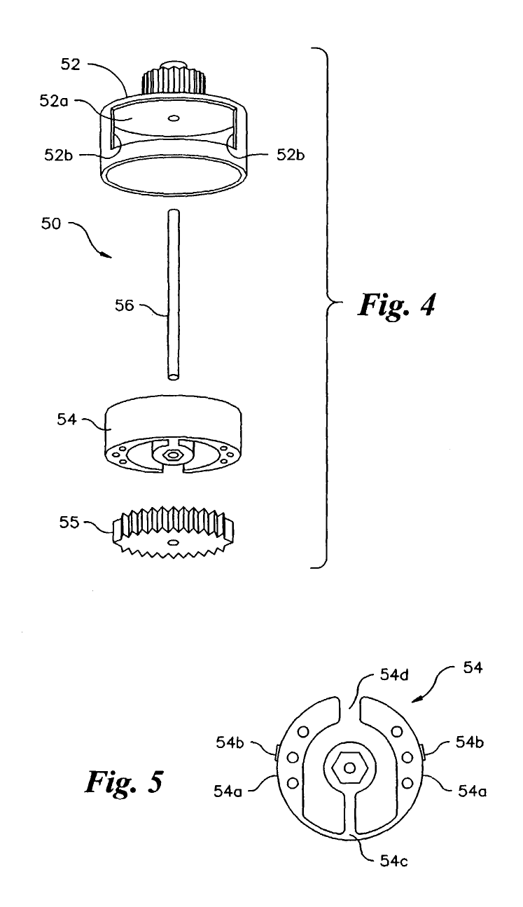

The clutch bell housing 52 has an opening 52a, preferably elongated and rectangular, with an axially extending leading edge 52b on each of the left and the right sides (circumferential ends) of the opening 52a in FIG. 4. When the clutch 54 rotates and the finger members 54a flex radially outwardly, one of the finger member protrusions 54b will enter the clutch bell housing opening 52a and rotate into facing engagement with one of the leading edges 52b, depending on which direction the drive motor 40 is rotating. Engagement in this way between the clutch 54 and the clutch bell housing 52 causes both to rotate at the same speed without slippage. This, in turn, causes the second combined gear 44 and the first spur gear 46 each to rotate, thereby causing rotation of the drive wheels 14, propelling the vehicle 10. It will be appreciated that clutch assembly 50 can be designed to transmit rotation in opposing directions by making opposing sides of each protrusion 54b generally planar and parallel to the central axis of shaft 56 and can make the assembly 50 a one-way or overrunning clutch by appropriately sloping one of the two opposing sides of each protrusion 54b with respect to the central axis to cam the protrusion from the opening 52a.

Referring to FIGS. 3, 6, and 7, the vehicle 10 mechanically produces noise at all times when the power switch 26 (FIG. 1) is turned on. At all times when the vehicle 10 is powered, the drive motor 40 runs. If the vehicle 10 is not being commanded by a user to move either forward or backward, the drive motor 40 rotates at a speed below the threshold speed so as not to engage the toy clutch assembly 50 and propel the vehicle 10. However, rotation of the drive motor 40 in either direction or at any speed causes rotation of the second spur gear 48. The second spur gear 48 is the source of the noise produced by the vehicle 10, the noise intended to simulate the sound of a real go-cart motor. The second spur gear 48 is freely rotatable about the drive wheel axle 15 so that noise can be produced whether or not the vehicle 10 is moving.

The second spur gear 48 has four pivot members 49 rotatably engaged with and equally spaced about one (generally) circular (annular) face of the second spur gear 48. The pivot members 49 are pivotally mounted to the second spur gear 48 at pivots 48a located generally circumferentially spaced around the drive wheel axle 15 through the second spur gear 48. Each pivot member 49 has an elongate projection 49a extending outwardly from the pivot 48a of the pivot member 49. Interspersed between pivot members 49 are abutments 48b. The abutments 48b are L-shaped and situated such that, depending upon the rotation of the second spur gear 48, the centripetal force will cause either the pivot members 49 to abut the short side of the abutments 48b so that the projections of the pivot members 49 extend outwardly radially from the center of the second spur gear 48 (during a forward direction of rotation) or abut the long side of the abutments 48b so that the projections of the pivot members 49 remain proximate the center of the second spur gear 48 (during a backward direction of rotation). Rotation in a forward direction causes the projections of the pivot members 49 to extend outwardly from the center of the second spur gear 48 and come into contact with a drum protrusion 58b extending downwardly from a small hollow plastic drum 58 engaged with and extending through the top of the drive mechanism housing cover 38a. This percussive contact between the projections of the pivot members 49 and the drum protrusion 58b, when quickly and successively repeated, approximates the sound of the engine of an actual go-cart. The noise produced is amplified within the drum 58, exiting the drum through a drum opening 58a and entering a hollow muffler 24 (FIG. 1) engaged with the top cover 16 (FIG. 1). The sound then exits the muffler 24 through a muffler opening 24a (FIG. 1) so that it would seem as though the vehicle 10 were producing actual motor noise.

In operation, the vehicle 10, when turned on but not commanded to go either forward or backward, will produce motor noise but not move forward because the drive motor 40 is rotating at a speed that is less than the engagement speed of the toy clutch assembly 50. When the vehicle 10 is commanded to go either forward or backward, the drive motor 40 rotates at a speed higher than the engagement speed, thereby engaging the toy clutch assembly 50 as described above and causing the vehicle 10 to be propelled.

The operation of the toy clutch assembly 50 provides either complete disengagement, thereby allowing the vehicle 10 to produce noise but not move, or complete engagement, thereby allowing power to be transferred from the drive motor 40 to the drive wheels 14 with no power loss due to slippage of the toy clutch assembly 50 and causing the vehicle 10 to move and produce noise. This two-state toy clutch assembly 50 is made possible by the interference engagement between the finger member protrusion 54b and the clutch bell housing opening leading edge 52b when the clutch 54 is rotated at speeds higher than the engagement speed. The two-state toy clutch assembly 50 of the present invention allows for smooth forward and backward operation of the vehicle 10. Use of an ordinary frictional clutch would result in jerky forward and backward motion and/or slow acceleration of the vehicle 10 due to partial clutch engagement (slippage), especially when encountering rough terrain or upward hills.

It will be appreciated by those skilled in the art that changes could be made to the embodiments described above without departing from the broad inventive concept thereof. For example, while a separate chassis/separate body construction is disclosed, the vehicle may be formed by a pair of mated half-shells or other monocoque construction. “Chassis” is intended to cover both a conventional chassis supporting a separate mounted body and also a monocoque construction in which the body also functions as a chassis bearing loads on the vehicle. Although an electric motor and a gas engine are disclosed, other motors (i.e., spring, inertia wheel, compressed air) might supply rotary output through such clutch assembly.

Although above-described toy clutch assembly 50, consisting of the clutch bell housing 52, the clutch 54, and the clutch gear 55, rotates about the clutch shaft 56, it is within the spirit and scope of the present invention that an element may be rigidly engaged with the clutch shaft 56 such that it rotates with the clutch shaft 56. Such rigid engagement of either the clutch 54 or the clutch bell housing 52 with the clutch shaft 56 may also eliminate the need for clutch gear 55 and/or the gear portion of the clutch bell housing 52. It is further within the spirit and scope of the present invention that the toy clutch assembly 50 is engaged with either the drive motor 40 or the drive wheel axle 15 through means other than gears, such as belts and rigid links. Lastly, the present invention is not limited to use with toy vehicles; it may be used with any toys with motors. The motors with which the toy clutch assembly 50 may be used are not limited to electric; they may be of any type, including hydraulic, pneumatic, and spring.

It is understood, therefore, that this invention is not limited to the particular embodiments disclosed, but it is intended to cover modifications within the spirit and scope of the present invention as defined by the appended claims.

I/we claim:

1. A toy clutch assembly comprising:
a bell housing having at least one opening with a leading edge, the bell housing being mounted for rotation about a central axis; and
a clutch maintained at all times at least partially within the bell housing and rotatable within the bell housing about the central axis, the clutch having at least one resiliently flexible finger member with an end that resiliently flexes outwardly away from the central axis during rotation, the at least one finger member having at least one small protrusion extending in a direction outwardly away from the central axis, the at least one protrusion engaging with the leading edge when the finger member flexes outwardly at an engagement speed of the clutch.

2. The toy clutch assembly of claim 1 in a combination further comprising:
a drive motor; and
at least one toy vehicle drive wheel operably coupled through the clutch assembly with the drive motor such that rotation of the drive motor is selectively transferred to the at least one drive wheel upon engagement of the clutch assembly.

3. The combination of claim 2 further comprising:
a toy vehicle chassis supporting the at least one toy vehicle drive wheel proximate a rear end of the chassis;
a steering actuator supported proximate the front of the chassis; and
at least one steering wheel pivotably engaged proximate the front of the chassis, the at least one steering wheel being freely rotatable about a steering shaft, the steering wheel being operably engaged with the steering actuator such that inputs from the steering actuator cause the at least one steering wheel to pivot about its connection point with the chassis.

4. The combination of claim 3 wherein the toy vehicle has two drive wheels.

5. The combination of claim 3 wherein the toy vehicle has two steering wheels.

6. The combination of claim 3 wherein the toy vehicle has two drive wheels and two steering wheels.

7. The combination of claim 2 having a noise-producing assembly, the noise-producing assembly comprising:
a rotatable gear having rotatable pivot members, the gear being operably engaged with the drive motor, each pivot member having an elongated extension extending outwardly from a pivot point of the pivot member, and
a hollow drum having a protrusion extending outwardly from a side of the drum, the drum being located proximate the gear;
wherein the elongated extensions of the pivot members extend outwardly from a center of the gear in reaction to centripetal force caused by rotation of the gear, the elongated extensions coming into contact with the protrusion of the drum and producing a tapping sound, the drum amplifying the tapping sound, such that the tapping sound simulates the sound of an actual combustion engine.

8. The combination of claim 2 wherein the toy vehicle is a four wheeled remotely-controlled go-cart.
